(19) United States
(12) Patent Application Publication
(10) Pub. No.: US 2006/0158844 A1
(43) Pub. Date: Jul. 20, 2006

(54) Heat dissipation mechanism for a base plate

(76) Inventor: Frederick Lee, Hsinchu City (TW)

Correspondence Address: LEONG C LEI, PMB # 1008, 1867 YGNACIO VALLEY ROAD, WALNUT CREEK, CA, 94598, US

(21) Appl. No.: 11/036,141

(22) Filed: Jan. 18, 2005

(51) Int. Cl. G06F 1/20

(52) U.S. Cl. 361/687

(57) ABSTRACT

A heat dissipation mechanism for a base plate is disclosed. The heat dissipation mechanism comprises rack and a fan mounted to the rack and the rack providing as an upper rack body for holding the base plate of a product and as a lower rack body for placing onto a platform, characterized in that at least a branching arm is mounted between the front and rear linking rod of the upper rack body and the lower rack body, and the fan is adjustably mounted onto the branching arm, thereby the position or angle of the fan on the rack can be changed in accordance with the exact area and heating point of the base plate of the product. The base plate heat dissipation mechanism is used in note book computer, lap-top computer, PDA, DVD or game devices such as H-box or PS/2 or the like.

### BACKGROUND OF THE INVENTION

(a) Technical Field of the Invention

The present invention relates to heat dissipation mechanism, and in particular, a heat dissipation mechanism which is applied together with an electronic product so that a strong convection current of cool air is obtained.

(b) Description of the Prior Art

In conventional heat dissipation devices, heat dissipation fans are commonly used for the reason that the structure of the fan is simple and the cost is cheap. Some electronic products, such as note book computer, lap-top computer, PDA, DVD, digit game devices (H-Box or PS/2) or the like are mounted a heat dissipation fan. However, the heat dissipation in such device is not sufficient and therefore the longevity of the product is affected.

Accordingly, it is an object of the present invention to provide a heat dissipation mechanism for a base plate which will mitigate the above drawbacks.

### SUMMARY OF THE INVENTION

The primary purpose of the present invention is to provide a heat dissipation mechanism for a base plate having a rack and a fan mounted to the rack and the rack providing as an upper rack body for holding the base plate of a product and as a lower rack body for placing onto a platform, characterized in that at least a branching arm is mounted between the front and rear linking rod of the upper rack body and the lower rack body, and the fan is adjustably mounted onto the branching arm, thereby the position or angle of the fan on the rack can be changed in accordance with the exact area and heating point of the base plate of the product.

Yet still another object of the present invention is to provide a heat dissipation mechanism for a base plate, wherein the upper rack body is provided with a mechanism which allows the positioning of the rear linking rod and the positioning of the restoration of the rear linking rod, and the mechanism includes pneumatic cylinder or hydraulic cylinder connected between the two side linking rod of the upper and lower rack, the retraction of the cylinder is employed to control the retraction of the upper rack body, or an elastic element to provide power to the rack body is mounted at the two side linking rod of the upper and lower rack body, and an engaging button secures the upper rack body at an extended position or a retracted position.

A further object of the present invention is to provide a heat dissipation mechanism for a base plate, wherein a sliding mount structure is provided at the external edge of the rack seat of the fan, and the sliding mount is used for the installation of the branching arm.

Yet a further object of the present invention is to provide a heat dissipation mechanism for a base plate, wherein the front linking rod and the branching arm is mounted a block to prevent a product from falling and an anti-sliding block, which can enhance the stability of the swinging of the base plate of the product.

Still yet another object of the present invention is to provide a heat dissipation mechanism for a base plate, wherein the upper and lower rack body are provided with a sliding slot for the mounting of a branching arm which provides front and rear balancing and the sliding slot of the upper rack body further forms into fastening slot so that the branching arm is flexibly adjusting the front and rear securing posing of an engaging button on the rack.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the heat dissipation mechanism of a base plate of the present invention.

FIG. 2 is a schematic view showing the adjusted position of the fan on the branching arm of the heat dissipation mechanism of a base plate of the present invention.

FIG. 3 is a top view of the rotating angle of the fan on the branching arm of the heat dissipation mechanism of a base plate of the present invention.

FIG. 4 is a schematic view of the heat dissipation mechanism of a base plate of the present invention.

FIG. 5 is a schematic view of the retraction of the rack of the heat dissipation mechanism of a base plate of the present invention.

FIG. 6 is a schematic view showing the implementation of the heat dissipation mechanism of a base plate of the present invention.

FIG. 7 is a schematic view of the rack in combination with the wrist-protection pad in accordance with the present invention.

FIG. 8 schematically shows the elastic member and the engaging button between the upper and the lower rack body of the present application.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

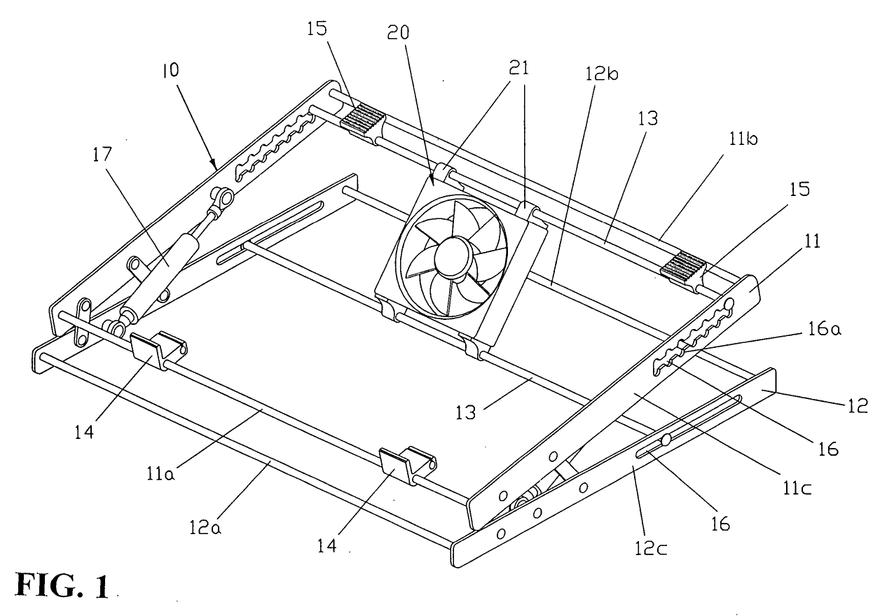

Referring to FIG. 1, there is shown a heat dissipation mechanism for a base plate comprising a rack 10, a fan 20 mounted onto the rack 10. The rack 10 includes an upper rack body 11, which allows the base plate of a product to be placed thereon and a lower rack body 12 which can be steadily placed onto a platform. The rack 10 is a framework, which is interlinked by the lower rack body 12 and the upper rack body 11 to provide a good ventilation structure.

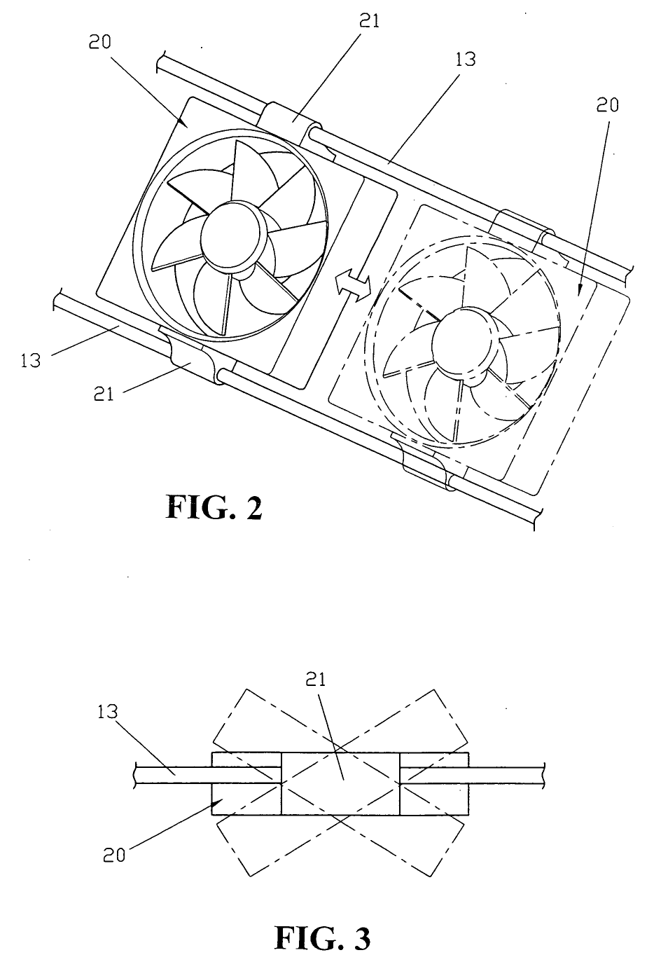

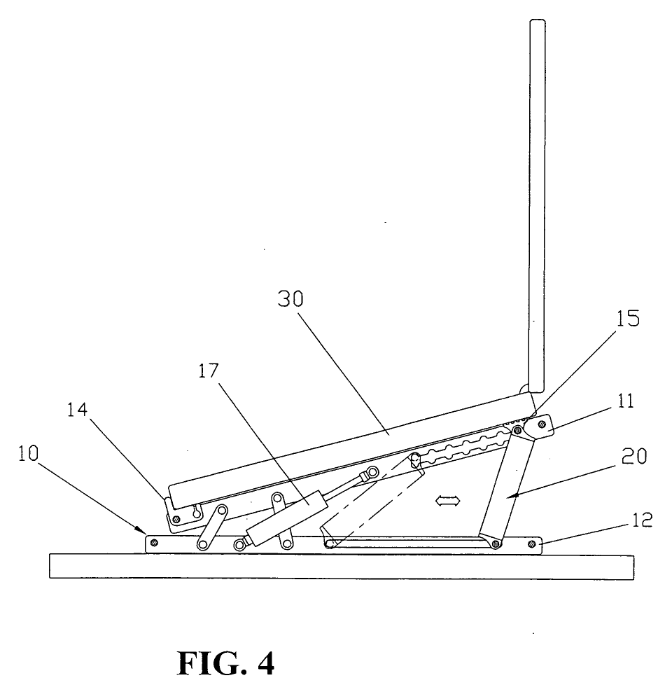

In accordance with the present invention, there is at least a branching arm 13 mounted between the front linking rods 11a, 12a and the rear linking rods 11b, 12b provided to the upper rack body 11 and the lower rack body 12. The external edge of the rack seat of the fan 20 is provided with a sliding mount structure for the mounting of the branching arm 13 onto the rack. As shown in FIGS. 2 and 4, when the base plate of an electronic product 30 is placed onto the upper rack body 11, the user can easily slide the fan 20 to an angle when the heat point of the product 30 is located. At this position, a convection current will provide a cooling effect to the electronic product 30.

As shown in FIGS. 2 and 3, the rack seat of the fan 20 and the sliding mount 20 can be formed on a corresponding shaft so that the fan 20 can be adjusted to provide a best heat dissipation position. Referring to FIGS. 1, 4 and 5, the upper rack body 11 is provided with a block 14 onto the front linking rod 11a such that product 30 having a bottom edge can be held and the branching arm 13 is mounted with an anti sliding block 15 and the top face of the anti sliding block 15 is formed from plastic or foamed material so as to avoid sliding at the base plate. Referring to FIGS. 1, 4 and 6, the upper and lower rack body 11, 12 are provided with corresponding sliding slot 16 for mounting the branching arm 13 so as to control the displacement thereof The sliding slot 16 of the upper rack body is further provided with an engaging slot 16a so that the branching arm 13 is elastically adjusted the front and rear securing on the rack. The front and rear securing position of the branching arm 13 can be easily adjusted so as to allow the steadily placement of electronic product with various base plate size and a strong convection current is provided to cool the base plate of the electronic product.

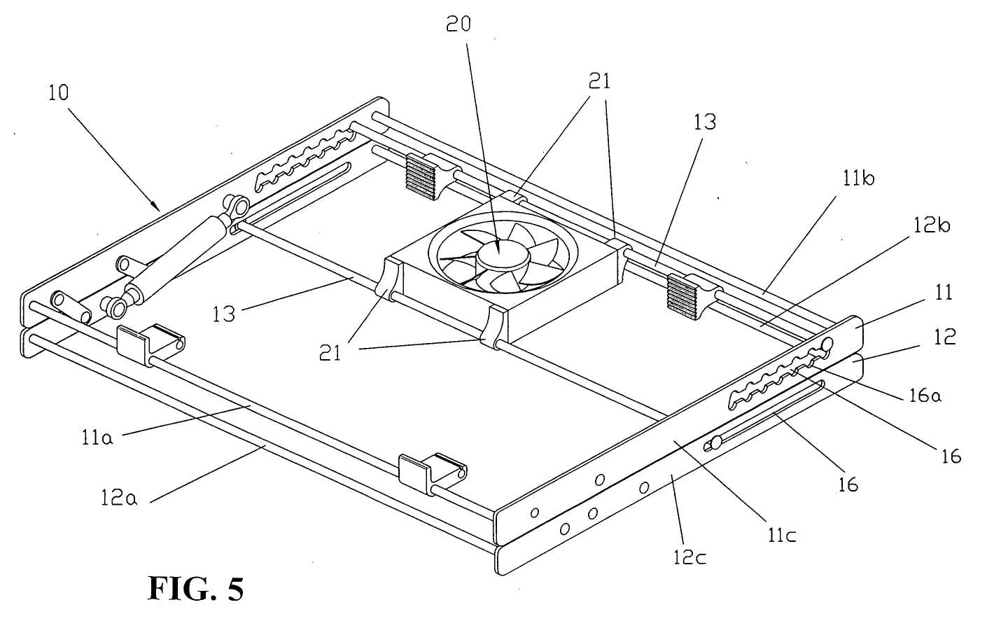

As shown in FIGS. 1 and 5, the rear liking rod 11b can be upwardly extended or retracted so as to provide easy operation of the product and facilitate the folding of the upper and lower rack body for storage. As shown in FIGS. 1 and 5, a pneumatic or hydraulic cylinder 17 is provided between the linking boards 11c, 12c and the shaft of the cylinder allows retraction and extension. As shown in FIG. 8, an elastic element 18 is used to provide pulling or retraction of the upper rack body, and an engaging button 19 to secure the upper rack body at the extended position or the retracted position.

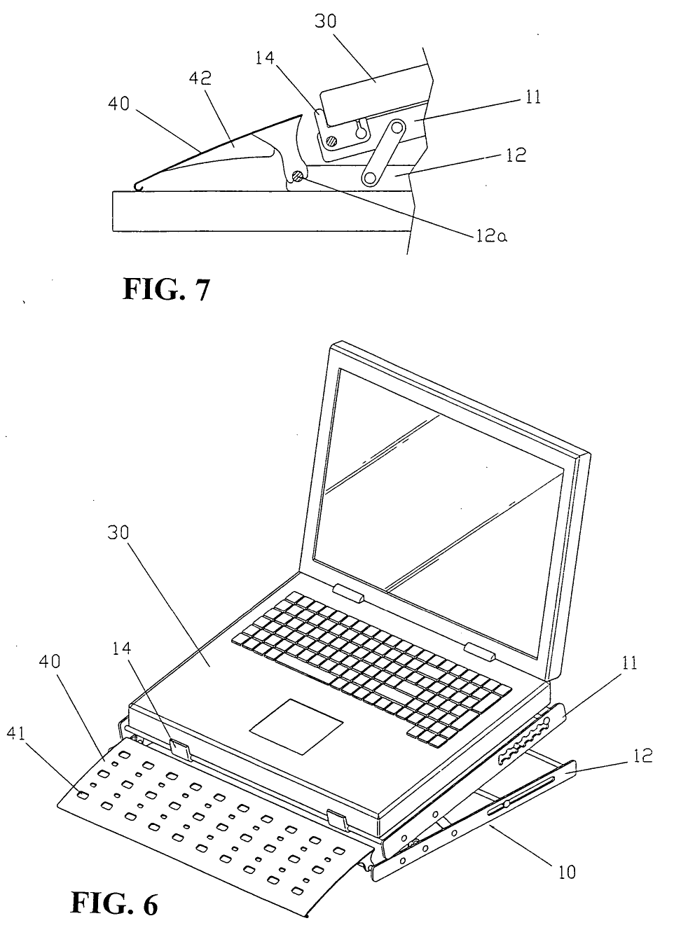

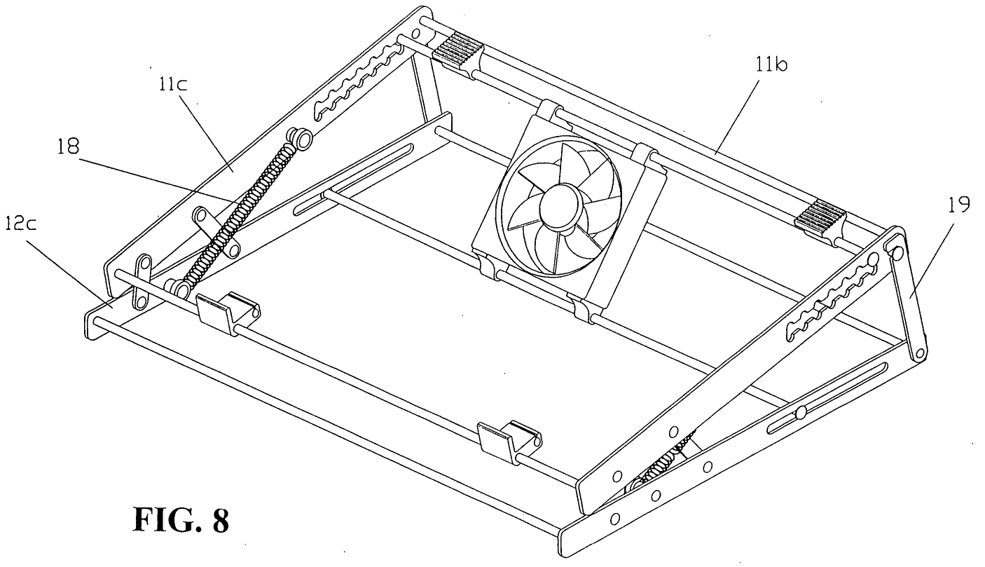

In accordance with the preferred embodiment of the present invention, as shown in FIGS. 6 and 7, the linking rod 12a of the lower rack body 12 provides an option to the user to suspend the wrist protection pad board 40 so as to facilitate the convenience of operating the electronic product 30 which needs an operation interface. The plate surface of the pad board 40 is provided with a plurality of holes 41 and the bottom end of the plate surface is provided with a plurality of guiding plate 42 to reduce wind resistance and to promote movement of hot air so as to enhance heat dissipation effect.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A heat dissipation mechanism for a base plate having a rack and a fan mounted to the rack and the rack providing as an upper rack body for holding the base plate of a product and as a lower rack body for placing onto a platform, characterized in that at least a branching arm is mounted between the front and rear linking rod of the upper rack body and the lower rack body, and the fan is adjustably mounted onto the branching arm, thereby the position or angle of the fan on the rack can be changed in accordance with the exact area and heating point of the base plate of the product.

2. The heat dissipation mechanism for a base plate of claim 1, wherein a sliding mount structure is provided at the external edge of the rack seat of the fan, and the sliding mount is used for the installation of the branching arm.

3. The heat dissipation mechanism for a base plate of claim 1, wherein the sliding mount and the rack seat are linked with a corresponding shaft.

4. The heat dissipation mechanism for a base plate of claim 1, wherein the front linking rod and the branching arm is mounted a block to prevent a product from falling and an anti-sliding block which can enhance the stability of the swinging of the base plate of the product.

5. The heat dissipation mechanism for a base plate of claim 1, wherein the upper and lower rack body are provided with a sliding slot for the mounting of a branching arm which provides front and rear balancing and the sliding slot of the upper rack body further forms into fastening slot so that the branching arm is flexibly adjusting the front and rear securing posing of an engaging button on the rack.

6. The heat dissipation mechanism for a base plate of claim 1, wherein the upper rack body is provided with a mechanism which allows the positioning of the rear linking rod and the positioning of the restoration of the rear linking rod, and the mechanism includes pneumatic cylinder or hydraulic cylinder connected between the two side linking rod of the upper and lower rack, the retraction of the cylinder is employed to control the retraction of the upper rack body, or an elastic element to provide power to the rack body is mounted at the two side linking rod of the upper and lower rack body, and an engaging button secures the upper rack body at an extended position or a retracted position.

7. The heat dissipation mechanism for a base plate of claim 1, wherein the front linking rod of the lower rack body is for the suspension of a wrist protection pad board.
